(19) United States
(12) Patent Application Publication
(10) Pub. No.: US 2018/0147989 A1
(43) Pub. Date: May 31, 2018

(54) METHOD AND APPARATUS FOR REAR-MOUNTED VEHICULAR DISPLAY CONTROL SYSTEM WITH INTEGRATED BACK-UP CAMERA

(71) Applicant: Luminator Mass Transit, LLC, Plano, TX (US)

(72) Inventors: Dan Kelleher, Plano, TX (US); Scott Watters, Plano, TX (US); John F. Barr, Garland, TX (US); Xiaoping Zhou, Plano, TX (US); Marty Masias, Plano, TX (US)

(73) Assignee: Luminator Mass Transit, LLC, Plano, TX (US)

(21) Appl. No.: 15/824,406

(22) Filed: Nov. 28, 2017

Related U.S. Application Data
(60) Provisional application No. 62/427,614, filed on Nov. 29, 2016.

(51) Int. Cl. B60R 1/00; B60R 11/04; G09F 21/04; H04N 5/38

(52) U.S. Cl. CPC B60R 1/00; B60R 11/04; G09F 9/33; H04N 5/38; B60R 2300/802; G09F 21/048

(57) ABSTRACT

A vehicular-signage system includes a control unit electrically coupled to a vehicle. The control unit is adapted to receive signals from the vehicle related to the vehicle being placed in reverse. A display is electrically coupled to the control unit. The display is adapted to receive signals from the control unit related to the display of a message. A back-up camera is disposed with the display. The back-up camera is activated by the control unit responsive to the vehicle being placed in reverse. The back-up camera transmits a video to the control unit.

### CROSS-REFERENCE TO RELATED APPLICATIONS

This application claims priority to, and incorporates by reference the entire disclosure of U.S. Provisional Patent Application No. 62/427,614, filed on Nov. 29, 2016.

### BACKGROUND

### Field of the Invention

The present invention relates generally to control systems for vehicular signage and more particularly, but not by way of limitation, to control systems for vehicular signage that include a rear-mounted display having an integrated back-up camera.

History of the Related Art

Vehicular signage is commonly utilized on various modes of public transportation such as, for example, passenger buses. Vehicular signage generally includes at least one display positioned at a high-visibility area of the vehicle. Often, at least one such display is mounted on a rear of the vehicle. Traditionally, vehicular signage was unpowered and manually adjusted; however, various types of electronic displays have become commonplace in recent decades. Electronic vehicular displays are generally connected to a control unit. The control unit signals the electronic display to illuminate in such a manner as to display a message.

In addition to signage, public transportation vehicles, such as buses, also present several maneuverability issues owing mainly to their large size. One such difficulty in the maneuvering of public transportation vehicles is maneuvering while in reverse.

### SUMMARY

The present invention relates generally to control systems for vehicular signage and more particularly, but not by way of limitation, to control systems for vehicular signage that include a rear-mounted display having an integrated back-up camera. In one aspect, the present invention relates to a system for vehicular signage. The system includes a control unit electrically coupled to a vehicle. The control unit is adapted to receive signals from the vehicle related to the vehicle being placed in reverse. A display is electrically coupled to the control unit. The display is adapted to receive signals from the control unit related to the display of a message. A back-up camera is disposed with the display. The back-up camera is activated by the control unit responsive to the vehicle being placed in reverse. The back-up camera transmits a video to the control unit which video is displayed to an operator of the vehicle.

### BRIEF DESCRIPTION OF THE DRAWINGS

For a more complete understanding of the present invention and for further objects and advantages thereof, reference may now be had to the following description taken in conjunction with the accompanying drawings in which:

FIG. 1 is a schematic diagram of a vehicular-signage control system according to an exemplary embodiment;

FIG. 2 is a front perspective view of a rear-mounted vehicular display having an integrated back-up camera according to an exemplary embodiment;

FIG. 3 is a front plan view of a rear-mounted vehicular display having an integrated back-up camera according to an exemplary embodiment;

FIG. 4 is a rear perspective view of a rear-mounted vehicular display having an integrated back-up camera according to an exemplary embodiment;

FIG. 5 is an exploded view of a rear-mounted vehicular display having an integrated back-up camera according to an exemplary embodiment;

FIG. 6 is a front view of a stand-alone back-up camera according to an exemplary embodiment;

FIG. 7 is a bottom view of the stand-alone back-up camera of FIG. 6 according to an exemplary embodiment; and

FIG. 8 is a side view of the stand-alone back-up camera of FIG. 6 according to an exemplary embodiment.

### DETAILED DESCRIPTION

Various embodiments of the present invention will now be described more fully with reference to the accompanying drawings. The invention may, however, be embodied in many different forms and should not be construed as limited to the embodiments set forth herein.

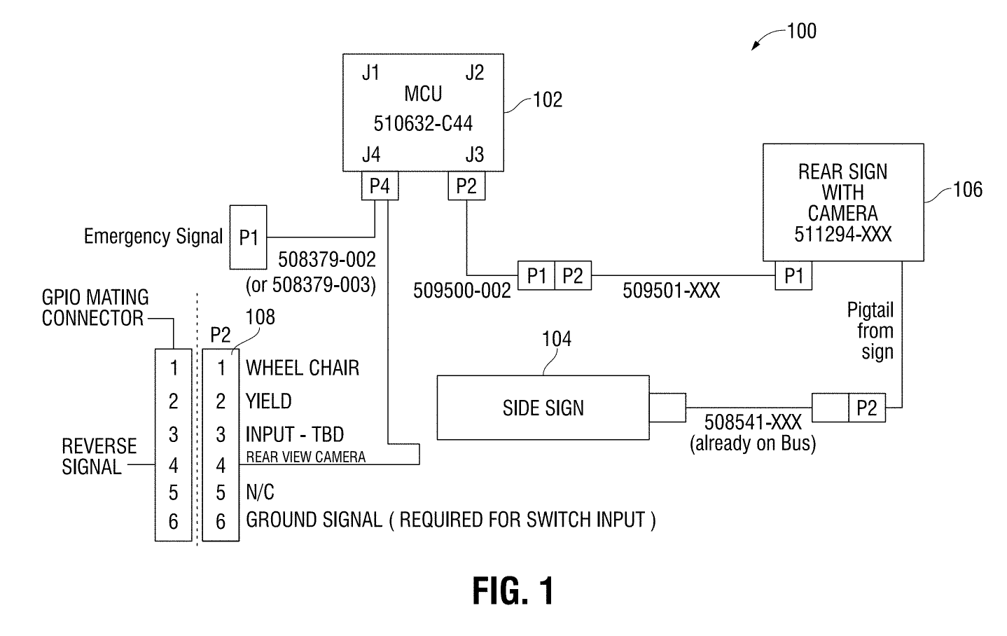

FIG. 1 is a schematic diagram of a vehicular-signage control system 100. The vehicular signage control system 100 includes a control unit 102. The control unit 102 is electrically coupled to at least one side display 104 and a rear-mounted display 106. In a typical embodiment, the at least one rear-mounted display 106 includes an integrated back-up camera. As illustrated in FIG. 1, the at least one side display 104 and the rear-mounted display 106 are electrically coupled in series to the control unit 102; however, in other embodiments, the at least one side display 104 and the rear-mounted display 106 could be coupled to the control unit 102 in a parallel arrangement. In a typical embodiment, the at least one side display 104 and the rear-mounted display 106 are arranged on a vehicle such as, for example, a passenger bus. In such an embodiment, the at least one side display 104 and the rear-mounted display 106 might, for example, display route information, messages, emergency alerts, or graphical images. In a typical embodiment, the control unit 102 provides a signal to the at least one side display 104 and the rear-mounted display 106 related to the display of a message. In various embodiments, the message may include graphical images, numeric characters, text characters, or any other necessary characters. In a typical embodiment, the at least one side display 104 and the rear-mounted display 106 are connected to the control unit 102 via a wired connection; however, in various other embodiments, vehicular-signage control systems utilizing principles of the invention may include side displays and rear-mounted displays that are connected to a control unit via any appropriate wireless protocol.

Still referring to FIG. 1, the control unit 102 is connected to a vehicular data port 108. In a typical embodiment, such a connection is by way of a general purpose input/output (GPIO) connector; however, in other embodiments, any appropriate connection capable of transmitting both electrical power and data may be utilized. In a typical embodiment, the control unit is connected to the data port 108 via a wired connection; however, in various other embodiments, vehicular-signage control systems utilizing principles of the invention may include a control unit that is connected to a vehicular data port via any appropriate wireless protocol. In a typical embodiment, the control unit 102 receives electrical power from a vehicle via the vehicular data port 108. Additionally, the control unit 102 receives a signal from the vehicular data port corresponding to the vehicle being placed in reverse. Still referring to FIG. 1, the control unit 102 is electrically coupled to an emergency signal 103. In a typical embodiment, the emergency signal 103 is a switch such as, for example, a floor-mounted switch near the operator of the vehicle. When the emergency signal 103 is activated by the operator of the vehicle, the at least one side display 104 and the rear-mounted display 106 display an emergency message such as, for example, “Call 911.”

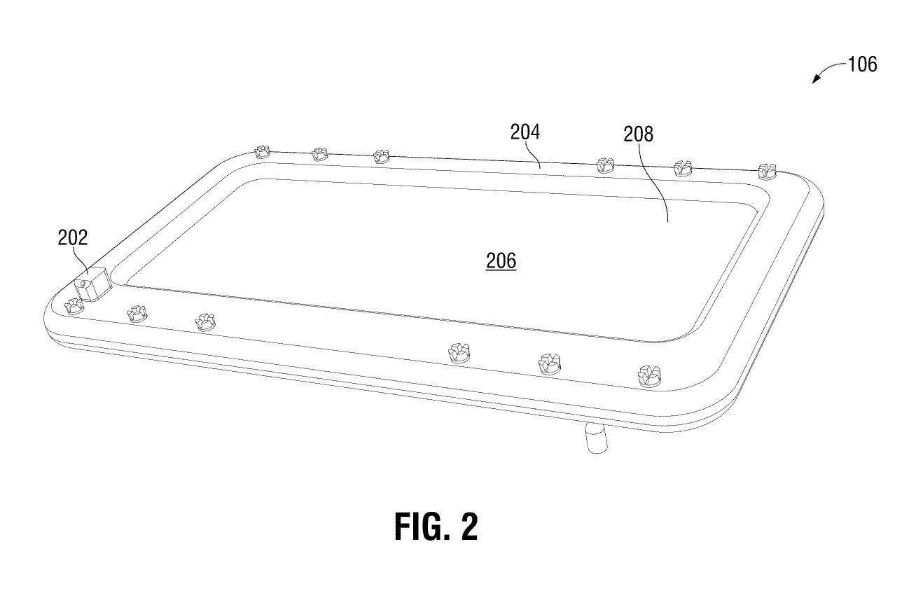

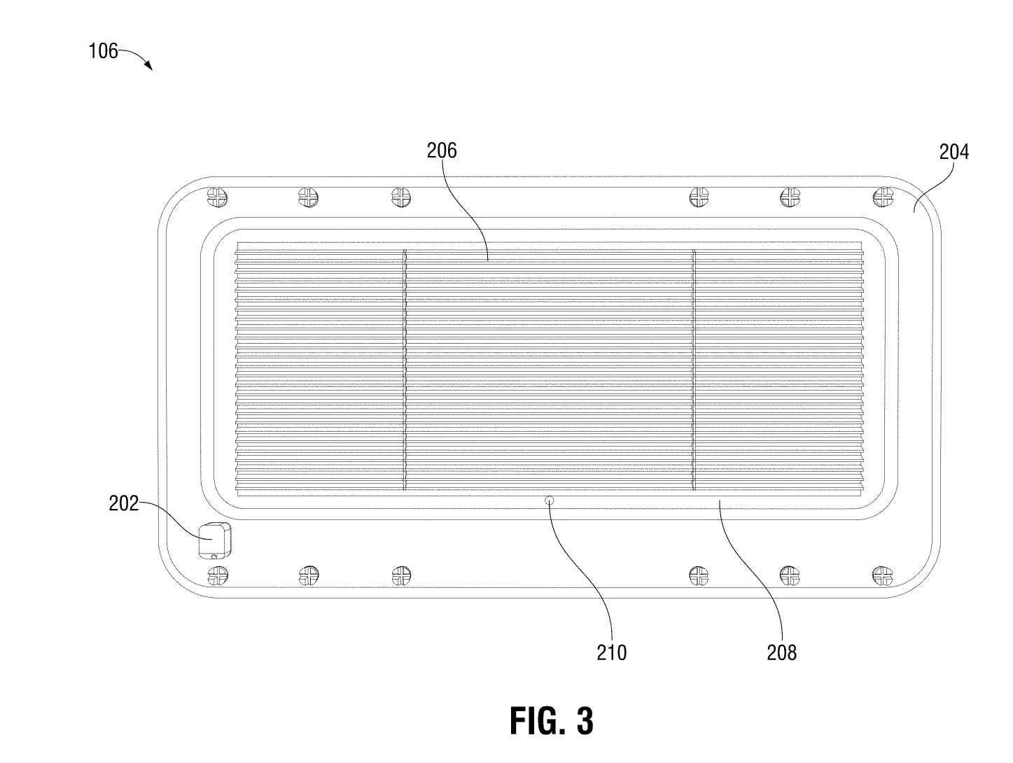

FIG. 2 is a front perspective view of the rear-mounted display 106 having an integrated back-up camera 202. FIG. 3 is a front plan view of the rear-mounted display 106 having the integrated back-up camera 202. Referring to FIGS. 2-3 collectively, the rear-mounted display 106 includes a cover 204. An electronic display 206 is disposed within the cover 204 and is visible through the cover 204. In a typical embodiment the cover 204 includes a lens 208 that overlies the electronic display 206. In a typical embodiment, the electronic display is, for example, a light-emitting diode (LED) display; however, in other embodiments, any appropriate electronic display can be utilized as dictated by design requirements. The back-up camera 202 is disposed on the cover 204 at a location that does not interfere with visibility of the electronic display 206. In a typical embodiment, the back-up camera 202 is oriented to capture a video of an area immediately behind the vehicle such as, for example, a passenger bus. In various embodiments, the back-up camera 202 is oriented at a slightly downward angle to allow visibility of, for example, pedestrians, vehicles, and other obstructions that are positioned below a level of the back-up camera 202.

Referring now to FIG. 3, a photo sensor 210 is positioned with the electronic display 206. In a typical embodiment, the photo sensor 210 determines a quantity of ambient lighting present around the electronic display 206 and transmits a signal to the control unit 102 corresponding to the quantity of ambient lighting. Responsive to the level of ambient lighting, a brightness of the electronic display 206 is adjusted. In various embodiments, brightness of the electronic display 206 is adjusted by a controller within the rear-mounted display 106. However, in other embodiments, the brightness may be adjusted by the control unit 102. Thus, the photo sensor 210 allows the brightness of the electronic display 206 to be adjusted to ambient conditions.

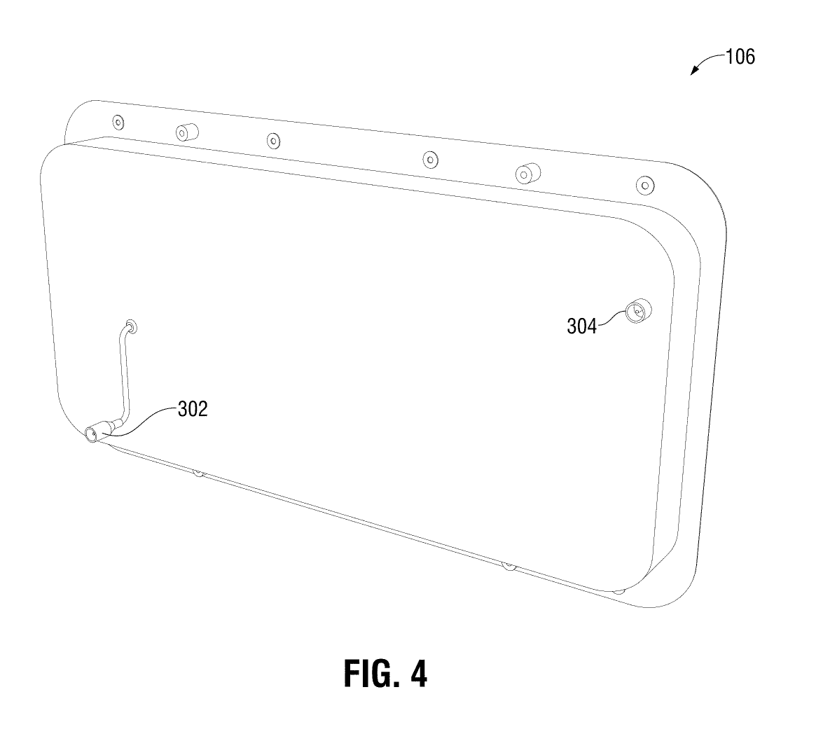

FIG. 4 is a rear perspective view of the rear-mounted display 106 having the integrated back-up camera 202. The rear-mounted display 106 includes a first port 302 and a second port 304. In a typical embodiment, the first port receives electrical power from the control unit 102. Additionally, the first port 302 receives signals related to the display of a message on the electronic display 206. In a typical embodiment, the second port 304 transmits signals received from the back-up camera 202 to the control unit 102. In a typical embodiment, the signals transmitted via the second port 304 correspond to at least one video captured by the back-up camera 202. In a typical embodiment, the first port 302 and the second port 304 are circular plastic connectors (CPC). In particular, in the embodiment illustrated in FIG. 4, the first port 302 is a seven-pin CPC and the second port 304 is a four-pin CPC; however, in other embodiments, any type of connection could be utilized as dictated by design requirements.

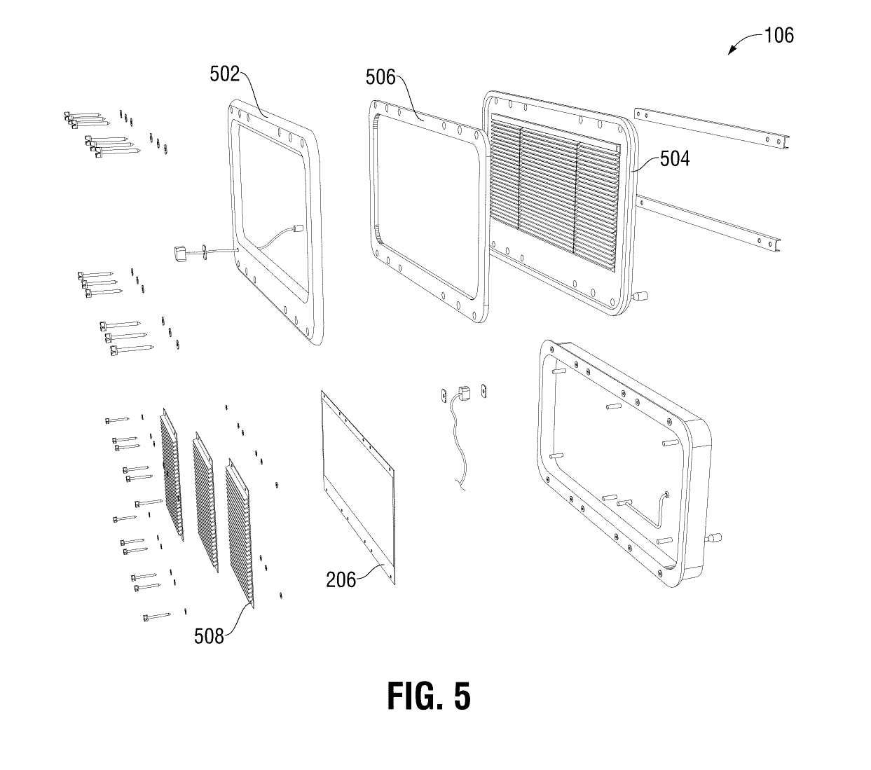

FIG. 5 is an exploded view of the rear-mounted vehicular display 106 having the integrated back-up camera 202. The rear-mounted display 106 includes the cover 204. The cover 204 includes a front cover portion 502 and a rear cover portion 504. A gasket 506 may, in various embodiments, be disposed between the front cover portion 502 and the rear cover portion 504. The electronic display 206 is enclosed by the front cover portion 502 and the rear cover portion 504. In various embodiments, a louver assembly 508 may be positioned in front of the electronic display 206 so as to direct visibility of the electronic display 206 in a particular direction. The back-up camera 202 is mounted to the front cover portion 502. In the embodiment shown in FIG. 5, the back-up camera 202 is mounted to a lower aspect of the front cover portion 502; however, in other embodiments, the back-up camera 202 could be mounted to the front cover portion 502 at any location. In still other embodiments, the back-up camera 202 could be integrally formed with the front cover portion 502.

Referring now to FIGS. 1-5 collectively, during operation, the control unit 102 transmits a signal to at least one of the side display 104 and the rear-mounted display 106. In various embodiments, the signal can cause the at least one side display 104 and the rear display 106 to display, for example, route information, messages, emergency alerts, or graphical images. When the vehicle such as, for example, a bus is placed in reverse, a reverse signal is transmitted through the vehicular data port 108 to the control unit 102. The reverse signal causes the control unit 102 to activate the back-up camera 202. During operation, the back-up camera 202 captures a video of the area directly behind the vehicle. The video is transmitted via the second port 304 to the control unit 102. The control unit 102 displays the video to an operator of the vehicle. In various embodiments, the control unit 102 contains an integral display; however, in other embodiments, the control unit is coupled to a stand-alone display. When the vehicle is shifted out of reverse, the reverse signal is no longer transmitted via the vehicular data port 108 to the control unit 102. When the control unit 102 no longer receives the reverse signal, the control unit 102 deactivates the back-up camera 202. Thus, in various embodiments, the back-up camera 202 is commonly controlled and powered with the rear-mounted display 106 and the at least one side display 104.

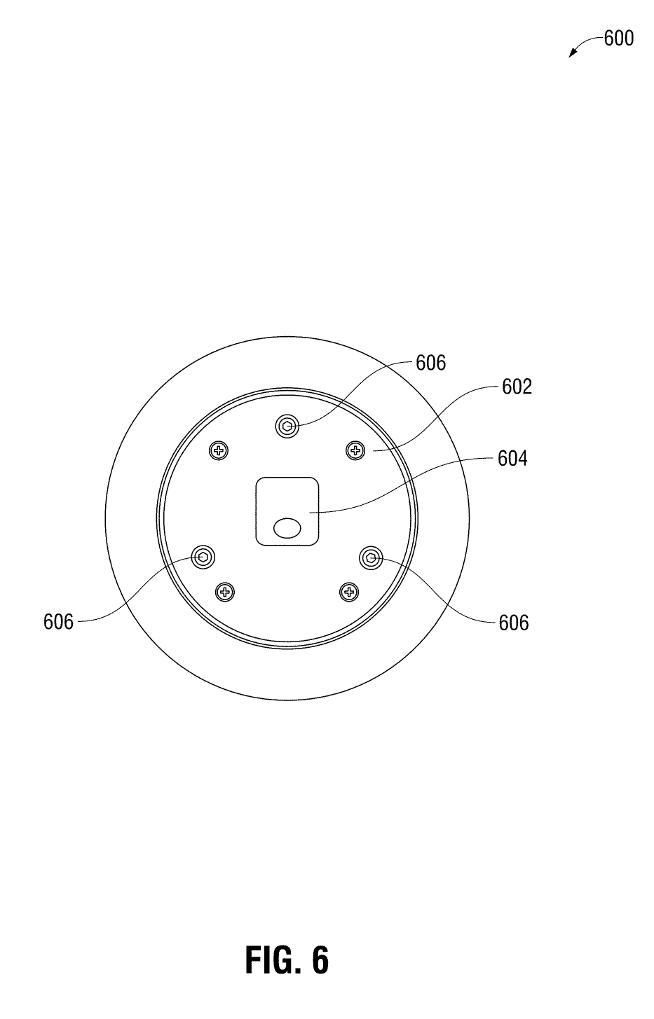

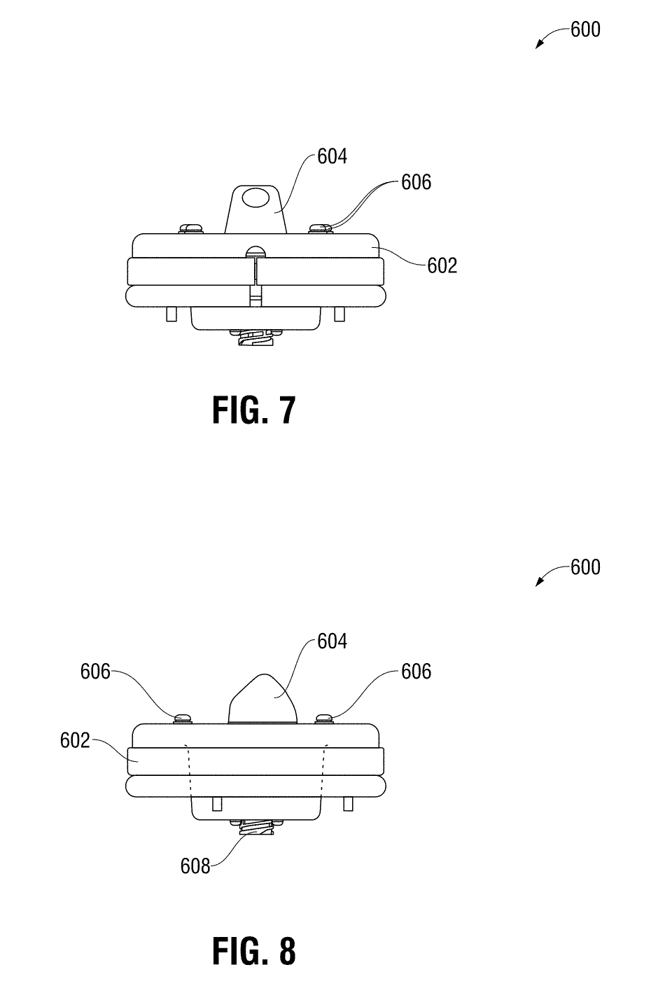

FIG. 6 is a front view of a stand-alone back-up camera 600. FIG. 7 is a bottom view of the stand-alone back-up camera 600. FIG. 8 is a side view of the stand-alone back-up camera 600. Referring to FIGS. 6-8 collectively, the stand-alone back-up camera 600 includes a base section 602 and a camera 604. In a typical embodiment, the base section 602 is generally circular in shape; however, in other embodiments, other shapes could be utilized. During use, the base section 602 is mounted to a rear surface of a vehicle. Mounting screws 606 are utilized to secure the base section 602 to the vehicle and to prevent accidental detachment. The camera 604 is located in an approximate center of the base section 602. In a typical embodiment, the camera 604 is oriented to capture a video of an area immediately behind the vehicle such as, for example, a passenger bus. In various embodiments, the camera 604 is oriented at a slightly downward angle to allow visibility of, for example, pedestrians, vehicles, and other obstructions that are positioned below a level of the camera 604. A wiring port 608 is included on the base section 602 on a side opposite the camera 604. In a typical embodiment, the wiring port 608 transmits signals received from the camera 604 to the control unit 102. The wiring port 608 also receives power from the control unit 102. In a typical embodiment, the signals transmitted via the wiring port 608 correspond to at least one video captured by the camera 604. In a typical embodiment, the wiring port 608 is a circular plastic connector (CPC). In particular, in the embodiment illustrated in FIGS. 6-8, the wiring port 608 is a four-pin CPC which is capable of transmitting both electrical power and video signals; however, in other embodiments, any type of connection could be utilized as dictated by design requirements. During operation, the stand-alone back-up camera 600 is coupled to an exterior of a vehicle such as, for example, a passenger bus with the mounting screws 606. Such an arrangement facilitates retrofitting of vehicles that do not make use of exterior signage.

Although various embodiments of the method and system of the present invention have been illustrated in the accompanying Drawings and described in the foregoing Specification, it will be understood that the invention is not limited to the embodiments disclosed, but is capable of numerous rearrangements, modifications, and substitutions without departing from the spirit and scope of the invention as set forth herein. It is intended that the Specification and examples be considered as illustrative only.

What is claimed is:

1. A system for vehicular signage, the system comprising:
a control unit electrically coupled to a vehicle and adapted to receive signals from the vehicle related to the vehicle being placed in reverse;
a display electrically coupled to the control unit, the display being adapted to receive signals from the control unit related to the display of a message;
a back-up camera disposed with the display, the back-up camera being activated by the control unit responsive to the vehicle being placed in reverse; and
wherein the back-up camera transmits a video to the control unit and the video is displayed to an operator of the vehicle.

2. The system of claim 1, wherein the back-up camera is downwardly angled.

3. The system of claim 1, where electrical power is supplied to the display and to the back-up camera via a first port.

4. The system of claim 3, wherein the first port is a seven-pin circular plastic connector.

5. The system of claim 1, wherein video data is delivered from the back-up camera to the control unit via a second port.

6. The system of claim 5, wherein the second port is a four-pin circular plastic connector.

7. The system of claim 1, wherein the display includes a louver assembly.

8. The system of claim 1, wherein the display includes a cover.

9. The system of claim 8, wherein the back-up camera is positioned on the cover.

10. A back-up camera for use in a vehicle, the back-up camera comprising:
a base section that is selectively securable to the vehicle;
a camera located on an exterior of the base section; and
a wiring connection electrically coupled to the camera and coupled to a controller.

11. The back-up camera of claim 10, wherein the camera is downwardly angled.

12. The back-up camera of claim 10, wherein the wiring connection is a four pin circular plastic connector.

13. The back-up camera of claim 10, comprising a gasket disposed between the base section and the vehicle.

14. The back-up camera of claim 10, comprising mounting screws that secure the base section to the vehicle.

15. A method of arranging a vehicular back-up camera, the method comprising:
electrically coupling a display to a vehicle controller;
electrically coupling a camera to the vehicle controller, the camera being disposed with the display;
electrically coupling the vehicle controller to a general purpose input/output port of the vehicle, the general purpose input/output port providing a signal when the vehicle is placed in reverse; and
responsive to the vehicle being placed in reverse, activating, via the vehicle controller, the camera.

16. The method of claim 15, comprising displaying to a vehicle operator an area behind the vehicle.

17. The method of claim 15, comprising displaying exterior messages via the display.

18. The method of claim 15, wherein the electrically coupling the display to the vehicle controller comprises utilizing a circular plastic connector.

19. The method of claim 15, wherein the electrically coupling the camera to the vehicle controller comprises utilizing a circular plastic connector.
